(19) United States
(12) Patent Application Publication
(10) Pub. No.: US 2017/0306135 A1
(43) Pub. Date: Oct. 26, 2017

(54) Improved Thermoplastic Polyolefin Design for Enhanced Stiffness, Toughness, and Viscosity Balance

(71) Applicant: ExxonMobil Chemical Patents Inc., Baytown, TX (US)

(72) Inventors: Jan Kalfus, Spring, TX (US); Patrick Brant, Seabrook, TX (US); Peijun Jiang, League City, TX (US); Abdul M. Jangda, Humble, TX (US)

(21) Appl. No.: 15/515,045

(22) PCT Filed: Aug. 21, 2015
(86) PCT No.: PCT/US2015/046250

§ 371 Date: Jun. 9, 2017

Related U.S. Application Data
(60) Provisional application No. 62/075,422, filed on Nov. 5, 2014.

(30) Foreign Application Priority Data
Feb. 3, 2015 (EP) 15453707.3

(51) Int. Cl. C08L 23/12

(52) U.S. Cl. CPC C08L 23/12; C08L 2314/02; C08L 2205/02; C08L 2207/02; C08L 2207/10

(57) ABSTRACT

Disclosed is a method of forming a thermoplastic polyolefin composition, and the TPO itself, comprising discrete α-olefin copolymer domains within a continuous phase of polypropylene comprising combining within the range from 8 wt % to 60 wt % of the α-olefin copolymer, by weight of the thermoplastic polyolefin, and within the range from 92 wt % to 40 wt % of the polypropylene by weight of the thermoplastic polyolefin, wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature.

### CROSS-REFERENCE TO RELATED APPLICATIONS

This invention claims priority to and the benefit of U.S. Ser. No. 62/075,422, filed Nov. 5, 2014, and EP application 15153707.3, filed Feb. 3, 2015, both incorporated by reference.

### FIELD OF THE INVENTION

The present invention relates to thermoplastic polyolefin compositions useful as impact copolymers and thermoplastic polyolefins.

### BACKGROUND OF THE INVENTION

The classic composition of an impact copolymer (“ICP”) or thermoplastic polyolefin (“TPO”) is a blend of a polypropylene homopolymer and an ethylene-propylene copolymer or rubber. When referring to an ICP, one is typically referring to an in situ blend, while a TPO is typically a physical blend. Both have advantages and disadvantages, but both would benefit by improved components and methods of combining the components.

Zeigler Natta (ZN) generated in situ reactor blends have enjoyed considerable success in the marketplace in spite of structural flaws inherent in their design due to the complex multi-sited nature of the ZN catalysts. Such compositions are particularly useful in automotive components. The flaws inherent in ZN generated ICPs can be overcome to some extent by extensive compounding with plastomers, fillers, and other additives. These compounded products are called Thermoplastic Polyolefins (TPOs). Compounding TPO's such as this adds to the cost of the product. Further, increasing automotive fuel standards have pushed such ZN ICPs to their limits of light-weighting/thin walling in automotive design. What is needed are TPOs or ICPs having improved performance and processing ability to meet the higher standards of current and future automotive and appliance standards.

Related references include U.S. Pat. No. 6,245,856; U.S. Pat. No. 6,271,311; U.S. Pat. No. 6,300,415; U.S. Pat. No. 6,506,857; U.S. Pat. No. 6,635,715; U.S. Pat. No. 6,642,316; U.S. Pat. No. 6,750,284; U.S. Pat. No. 6,921,794; U.S. Pat. No. 7,049,372; U.S. Pat. No. 7,166,674; U.S. Pat. No. 7,205,371; U.S. Pat. No. 7,413,811; U.S. Pat. No. 7,585,917; U.S. Pat. No. 7,619,038; U.S. Pat. No. 7,683,129; U.S. Pat. No. 7,947,786; U.S. Ser. No. 14/325,449, filed Jul. 8, 2014; and WO 94/00500.

### SUMMARY OF THE INVENTION

The present invention is directed to a method of forming a thermoplastic polyolefin composition comprising discrete α-olefin copolymer domains within a continuous phase of polypropylene comprising combining within the range from 8 wt % to 60 wt % of the α-olefin copolymer, by weight of the thermoplastic polyolefin, and within the range from 92 wt % to 40 wt % of the polypropylene by weight of the thermoplastic polyolefin, wherein the complex viscosity of the α-olefin copolymer (CV_{α-olefin}) and polypropylene (CV_{PP}) satisfy the formula 0.2, or 0.4≦CV_{α-olefin}/CV_{PP}≦2, or 3, or 4, or 5 when the CVs are measured at the same frequency and temperature.

The present invention is also directed to a thermoplastic polyolefin composition comprising discrete domains comprising (or consisting essentially of) within the range from 8 wt % to 60 wt % of the α-olefin copolymer, by weight of the thermoplastic polyolefin, and within the range from 92 wt % to 40 wt % of the polypropylene by weight of the thermoplastic polyolefin, wherein the complex viscosity of the α-olefin copolymer (CV_{α-olefin}) and polypropylene (CV_{PP}) satisfy the formula 0.2, or 0.4≦CV_{α-olefin}/CV_{PP}≦2, or 3, or 4, or 5 when the CVs are measured at the same frequency and temperature.

### BRIEF DESCRIPTION OF THE FIGURES

FIG. 1 is a graphical representation of the Complex Viscosity of two isotactic polypropylenes (70 and 35 MFR samples) as a function of Angular Frequency, as measured at 200° C. (ARES Rheometrics).

FIG. 2 is a graphical representation of the Complex Viscosity of three ethylene-propylene copolymers (1.0, 0.4, and 11 MFR samples) as a function of Angular Frequency, as measured at 200° C. (ARES Rheometrics).

FIG. 3 is a graphical representation of the Izod Impact (23° C.) of two TPOs as a function of Viscosity Ratio (30 wt % ethylene-propylene rubber in isotactic polypropylene).

FIG. 4 are SEM images of an inventive (Viscosity Ratio 1.7) and comparative (Viscosity Ratio 7.9) TPO compositions including an isotactic polypropylene and an ethylene-propylene copolymer (30 wt %).

FIG. 5 is a graphical representation of the Complex Viscosity of three ethylene-propylene copolymers (1.0, 0.4, and 11 MFR samples) and a 70 MFR isotactic polypropylene (“iPP”) as a function of Angular Frequency, as measured at 200° C. (ARES Rheometrics).

FIG. 6 is a graphical representation of the Complex Viscosity of three ethylene-propylene copolymers (1.0, 0.4, and 11 MFR samples) and a 35 MFR iPP as a function of Angular Frequency, as measured at 200° C. (ARES Rheometrics).

FIG. 7 is a graphical representation of the Izod Impact of several TPOs as a function of theoretical flexural modulus (E_{flex}) (30 wt % ethylene-propylene rubber in iPP).

FIG. 8 is a graphical representation of the MFR of high (35 MFR) and low (70 MFR) molecular weight polypropylene homopolymer blends with an ethylene-propylene rubber (“EPR”) (C₂=45-50 wt %), which is an “α-olefin copolymer” as used herein, as a function of EPR/PP viscosity ratio at 100 rad/sec.

FIG. 9 is a graphical representation of the Izod Impact (23° C.) of high and low molecular weight polypropylene homopolymer blends in FIG. 8 with an ethylene-propylene rubber (“EPR”) as a function of EPR/PP viscosity ratio at 100 rad/sec, and correlating that with the morphology of the TPO (30 wt % EPR in iPP).

### DETAILED DESCRIPTION OF THE INVENTION

Described here is an improved α-olefin copolymer/PP blend, hereinafter “Thermoplastic Polyolefin composition”, “TPO composition”, or simply “TPO”, that can be either an in situ blend or physical blend, and that can overcome the underperformance of current ICPs and TPOs in a cost effective way. In a preferred embodiment, design of the inventive TPO is based on metallocene or single-site generated components and harnesses the ability to make high crystallinity iPP, as well as narrow composition distribution (CD) α-olefin copolymer in solution phase processes. Examples are presented that illustrate the enhanced rheology and solid state performance afforded by this new approach.

The present invention is based on matching viscosities between the PP matrix and the α-olefin copolymer domains in TPOs in the melt state during compounding (extruder, kneader, injection molding machine, etc.), or while being produced in situ in series or parallel reactors. This allows for more efficient momentum transfer between molten components (PP and α-olefin copolymer) and, hence, achieving fine droplet morphologies during melt mixing which delivers high impact toughness of the finished product. This is in contrast to strategies used in most current industrial processes where the rubber component has preferably high molecular weight, which eventually causes steep increase of processing viscosities. To compensate for this disadvantage, a rather low molecular weight PP matrix (high MFR) is used. In the present invention, the viscosity match between PP and the α-olefin copolymer component allows for using higher molecular weight PP (MFR lower than 100 g/10 min) which provides higher strength to the finished blend due to higher number concentration of molecular entanglements. Sufficient incompatibility between PP and rubber causes that stiffness of the finished blend to correspond or is very close to the theoretical limit.

By the phrase “consisting essentially of” what is meant is that the composition as claimed contains no other additives, or additives only in an amount of no greater than 3 or 2 or 1 wt %. So called “additives” include, but are not limited to, processing oils, fire retardants, antioxidants, plasticizers, pigments, vulcanizing or curative agents, vulcanizing or curative accelerators, cure retarders, processing aids, flame retardants, tackifying resins, flow improvers, antiblocking agents, coloring agents, lubricants, mold release agents, nucleating agents, reinforcements, and fillers (including granular, fibrous, or powder-like) may also be employed. The phrase “consisting essentially of” also means that no other polyolefins and/or polystyrenes are present, other than the polypropylene and α-olefin copolymer, or, if present at all, to an extent no greater than 3 or 2 or 1 wt % of the composition, and most preferably are absent.

As used herein, a “Ziegler-Natta” catalyst is defined as a transition metal compound bearing a metal-carbon bond—excluding cyclopentadienyls or ligands isolobal to cyclopentadienyl—and able to carry out a repeated insertion of olefin units. Definitions and examples of Ziegler-Natta catalyst used for propylene polymers can be found in Chapter 2 of “Polypropylene Handbook” by Nello Pasquini, 2^{nd} Edition, Carl Hansen Verlag, Munich 2005. Examples of Ziegler-Natta catalysts include first and second generation TiCl₂ based, the MgCl₂ supported catalysts as described in the “Polypropylene Handbook” by N. Pasquini. The polypropylenes useful herein may be made using Ziegler-Natta catalysts.

As used herein, “metallocene catalyst” means a Group 4 or 5 transition metal compound having at least one cyclopentadienyl, indenyl or fluorenyl group attached thereto, or ligand isolobal to those ligands, that is capable of initiating olefin catalysis, typically in combination with an activator. Definitions and examples of metallocene catalysts can be found in Chapter 2 of “Polypropylene Handbook” by Nello Pasquini, 2^{nd} Edition, Carl Hansen Verlag, Munich, 2005. The polypropylenes and α-olefin copolymers may be produced in any embodiment using such catalysts.

As used herein, “single-site catalyst” means a Group 4 through 10 transition metal compound that is not a metallocene catalyst and capable of initiating olefin catalysis, such as Diimine-ligated Ni and Pd complexes; Pyridinediimine-ligated Fe complexes; Pyridylamine-ligated Hf complexes (e.g., U.S. Ser. No. 14/195,634, filed Mar. 3, 2014, U.S. Ser. No. 61/815,065, filed Apr. 23, 2013); Bis(phenoxyimine)-ligated Ti, Zr, and Hf complexes. Other examples of single-site catalysts are described in G. H. Hlatky “Heterogeneous Single-Site Catalysts for Olefin Polymerization,” 100 CHEM. REV., 1347-1376, (2000), and K. Press, A. Cohen, I. Goldberg, V. Venditto, M. Mazzeo, M. Kol, “Salalen Titanium Complexes in the Highly Isospecific Polymerization of 1-Hexene and Propylene,” in 50 AGNEW. CHEM. INT. ED., 3529-3532, (2011), and references therein. Examples of single-site catalysts include complexes containing tert-butyl-substituted phenolates ([Lig₁₋₃TiBn₂]), complex [Lig₄TiBn₂] featuring the bulky adamantyl group, the sterically unhindered complex [Lig₅TiBn₂]. The polypropylenes and α-olefin copolymers may be produced in any embodiment using such catalysts.

As stated above, the present invention is based on matching viscosities between the PP matrix and the rubber components in TPOs in the melt state during compounding (extruder, kneader, injection molding machine, etc.), or while being produced in series or parallel reactors. This “matching” is determined by the ratio of viscosities of the α-olefin copolymer and polypropylene at a certain shearing frequency, for example, at 5, 10, or 100 rad/s (at a temperature in between 190 and 230° C.). Thus, the invention includes a method of forming a thermoplastic polyolefin composition comprising discrete α-olefin copolymer domains within a continuous phase of polypropylene comprising combining within the range from 8, or 12, or 16 wt % to 30, or 40, or 50, or 60 wt % of the α-olefin copolymer, by weight of the thermoplastic polyolefin, and within the range from 92, or 90, or 88 wt % to 50, or 40 wt % of the polypropylene by weight of the thermoplastic polyolefin, wherein the complex viscosity of the α-olefin copolymer (CV_{α-olefin}) and polypropylene (CV_{PP}) satisfy the formula 0.2≦CV_{α-olefin/}CV_{PP}≦5 when the CVs are measured at the same frequency and temperature. Preferably, the CV_{α-olefin} and CV_{PP} are measured at a frequency within a range from 0.01, or 1, or 10, or 50 rad/sec to 80, or 100, or 150, or 200 rad/sec (at a temperature within a range from 190 and 230° C.) and combining them with a complex viscosity ratio (copolymer/polypropylene) measured at the same frequency, this test being described further below.

In any embodiment the domains α-olefin copolymer of are less than 1,000 or 900 or 800 or 600 or 400 nm in average diameter, or within a range of from 100, or 200 nm to 800, or 1,000 nm in average diameter. The particle size of the discrete phase is measured using ATM and SEM.

### The Polypropylene Component

As used herein, the term “polypropylene” refers to one or a combination of propylene-based polymers comprising at least 50 or 60 wt % propylene-derived units (by weight of the propylene-based polymer(s)), or a composition comprising propylene-based polymers having a total content of at least 50 or 60 wt % propylene-derived units. Examples of “polypropylene” include polypropylene homopolymers, ethylene-propylene copolymers, another propylene impact copolymers (e.g., an intimate blend of polypropylene homopolymer and an ethylene-propylene rubber), other thermoplastic polyolefin compositions (with and without fillers), and blends thereof. Preferably, “polypropylene” refers to polypropylene homopolymers and polypropylene copolymers, wherein polypropylene copolymers comprise within a range from 0.1 to 1, or 2, or 3, or 4, or 5 wt %, by weight of the polypropylene, ethylene and/or C₄ to C₁₀ α-olefins. Most preferably, the polypropylene is isotactic. The polypropylene component may be produced in situ with the α-olefin copolymer, in parallel or series, or made separately and then physically blended with the α-olefin copolymer in proportions where, preferably, the polypropylene forms the “continuous” phase of the TPO.

In any embodiment the polypropylene component may be unimodal or bimodal. When the polypropylene has a bimodal molecular weight distribution (M_{w}/Mₙ, MWD), the MWD is within the range of from 4.0, or 5.0 to 10.0, or 12.0, or 16.0, or 20. When the polypropylene component is unimodal, the MWD of less than 6.0, or 5.0, or 4.0, or within a range of from 1.8, or 2.0, or 2.5 to 4.0, or 6.0. By “bimodal”, what is meant is that there is a “spread” (or difference) in the melt flow rate (MFR) between at least two polypropylenes (a “first” and “second”) blended together by at least 10 or 20 g/10 min (or a difference in the Mw by at least 5,000 or 10,000 g/mole), which may be seen on a GPC plot as a typical bell-shaped curve with a “bump,” or two distinct bell-shaped curves, and shapes therebetween.

More particularly, when the “polypropylene” is bimodal it will include a so-called “first” and “second” polypropylene component. Both the “first” (HMW) and “second” (LMW) that is preferably used in the bimodal polypropylene compositions are a homopolymer or copolymer comprising from 0.1 to 5 wt %, by weight of the individual first and/or second PP components, C₂ and/or C₄ to C₁₀ α-olefin derived units as described above.

Generally speaking, the crystallinity is a major influence on the heat of fusion and melting temperature of the polypropylene. The term “crystalline,” as used herein, characterizes those polymers which possess high degrees of inter- and intra-molecular order. In any embodiment, the polypropylenes useful herein have a heat of crystallization (ΔHc) (DSC, ASTM D3418) within the range of from 80, or 85, or 90, or 100 J/g to 125, or 130, or 135 J/g; and a crystallization temperature (Tc) within the range of from 100, or 110, or 115, or 120° C. to 130, or 135, or 140, or 145, or 150, or 155, or 160, or 165, or 170° C. In any embodiment the polypropylene has a melting point (Tm, DSC, ASTM D3418) of greater than 140 or 150 or 155° C.; or within a range of from 130, or 140, or 145° C. to 155, or 160, or 165, or 170° C., as stated above.

In any embodiment the melt flow rate (MFR, 230° C./2.16 kg) of the polypropylene is from less than 100, or 85, or 80, or 75, or 50, or 40, or 30 g/10 min; or within a range of from 2, or 5, or 10, or 20 g/10 min to 30, or 40, or 50, or 75, or 80 or 85, or 100 g/10 min. The MFR of most polymers is related to the molecular weight as is known in the art. In any embodiment, the polypropylene has a weight average molecular weight (Mw) within a range from 120,000 or 140,000 g/mol to 200,000, or 240,000, or 260,000, or 300,000 or 400,000 or 600,000 g/mol; and a number average molecular weight (Mn) within a range from 20,000, or 25,000 g/mol to 40,000, or 45,000, or 50,000, or 60,000 g/mol; and a z-average molecular weight (Mz) within a range from 300,000, or 350,000 g/mol to 450,000, or 500,000, or 600,000, or 800,000 g/mol. Most preferably the polypropylene has a Mw of greater than 160,000 or 170,000 g/mol, or within a range from 160,000 g/mol to 600,000 g/mol.

In any case, the unimodal or bimodal polypropylene can be made by any desirable process using any desirable catalyst as is known in the art, such as a Ziegler-Natta catalyst, a metallocene catalyst, or other single-site catalyst, using solution, slurry, high pressure, or gas phase processes. Most preferably, the polypropylene is made in a solution process using a metallocene or other single-site catalyst. Suitable grades of polypropylene that are useful in the TPO compositions described herein include those made by ExxonMobil, LyondellBasell, Total, Borealis, Japan Polypropylene, Mitsui, Braskem, and other sources.

### The α-Olefin Copolymer Component

As used herein, the term “α-olefin copolymer” refers to one or a combination of ethylene-based copolymers or terpolymers comprising at least 30 or 40 wt % ethylene-derived units (by weight of the α-olefin copolymer(s)), or a composition comprising ethylene-based polymers having a total content of at least 30 or 40 wt % ethylene-derived units. In any embodiment, the α-olefin copolymer comprises within the range from 20, or 30, or 40 wt % to 55, or 60, or 70, or 80 wt %, by weight of the copolymer, ethylene derived units, and within the range from 20, or 30, or 40 wt % to 50, or 60, or 80 wt %, by weight of the copolymer, higher α-olefin derived units selected from one or more of propylene, 1-butene, 1-hexene, 1-octene, and, linear dienes. Most preferably, the α-olefin copolymer comprises within the range from 30, or 35 wt % to 45, or 50, or 55 wt %, by weight of the copolymer, ethylene derived units, and within the range from 45, or 50, or 55 wt % to 65, or 70 wt %, by weight of the copolymer, propylene, 1-butene, and/or 1-hexene derived units, and within a range from 0.05 or 0.1 wt % to 1, or 2, or 4 wt %, by weight of the α-olefin copolymer, of linear diene. So-called “linear dienes” are C6 to C20 olefins with two unsaturation sites, preferably at either end of the olefin chain, examples of which include 1,7-octadiene or 1,9-decadiene. Most preferably, the higher α-olefin is propylene. The α-olefin copolymer may be made by any means, but is most preferably formed in a solution process using a metallocene catalyst system.

Non-limiting examples of a suitable α-olefin copolymer component useful in the inventive TPOs include ethylene-propylene copolymer (EPR), ethylene-butene copolymer (EBR), and ethylene-octene copolymer (EOR). The molecular structure of the copolymer (Mn, Mw, molecular weight distribution, comonomer content, and branching) is tailored in a way that the α-olefin copolymer component has rheological behavior close to (within 15% or less) or matching the rheological behavior of the PP matrix. The α-olefin copolymer may or may not contain branches introduced during homogeneous solution polymerization by using linear dienes such as 1,7-octadiene or 1,9-decadiene.

Most preferably the α-olefin copolymer is formed by a polymerization reaction between ethylene, an amount of comonomer selected from one or more of propylene, butylene, hexane, octene, and linear diene, and a bridged hafnocene or zirconocene, most preferably a bridged, unbalanced hafnocene or zirconocene. By “unbalanced” what is meant is that the two primary cyclopentadienyl ligands, or ligand isolobal to cyclopentadienyl, are not the same, such as a cyclopentadienyl-fluorenyl hafnocene or zirconocene, or an indenyl-fluorenyl hafnocene or zirconocene, etc.

Also, in any embodiment, the α-olefin copolymer has a glass transition temperature (Tg) measured by DSC within a range from −60, or −55, or −50° C. to −20, or −10° C.

Also in any embodiment the α-olefin copolymer has an MFR (230° C./2.16 kg) of less than 20, or 18, or 16, or 14, or 10 g/10 min, or within the range from 0.1, or 1, or 2, or 4, or 6, or 8 g/10 min to 12, or 14, or 16 g/10 min. The α-olefin copolymer has a weight average molecular weight (Mw) within a range from 70,000, or 80,000, or 90,000 g/mol to 200,000, or 250,000, or 300,000, or 400,000 or 600,000 g/mol (GPC-DRI); and a number average molecular weight (Mn) within a range from 30,000, or 35,000, or 40,000 g/mol to 60,000, or 65,000, or 80,000, or 100,000 g/mol (GPC-DRI); and a z-average molecular weight within a range from 150,000, or 160,000, or 180,000 g/mol to 400,000, or 450,000, or 500,000, or 800,000 g/mol (GPC-DRI).

In any embodiment the α-olefin copolymer has a molecular weight distribution (M_{w}/Mₙ) of less than 6.0 or 5.0 or 4.0, or within a range of from 1.8, or 2.0, or 2.5 to 3.5 or 4.0, or 6.0.

Finally, in any embodiment the α-olefin copolymer is highly branched as characterized by a low g′ᵥᵢₛ; most preferably, the g′ᵥᵢₛ of the α-olefin copolymer is less than 0.90, or 0.85, or 0.80, or 0.75, or 0.70; or, alternatively, within a range of from 0.70 or 0.75 to 0.85 or 0.90.

### Blending and Polymerization Process

In any embodiment the “combining” step of the polypropylene and α-olefin copolymer takes place when the shear viscosities of the α-olefin copolymer and polypropylene components satisfy the formula 0.2, or 0.4≦CV_{α-olefin/}CV_{PP}≦2, or 3, or 4, or 5 when the CVs are measured at the same frequency and temperature; or at the shear viscosity at which the complex viscosity of the polypropylene and α-olefin copolymer is within 5 or 10 or 15% of one another. As mentioned, “combining” can take place by intimate blending of the at least two polymeric components by either physical blending in an extruder or other mechanical blender, or by “in situ” reactor mixing in a polymerization process means, either in series or parallel, and most preferably in a solution polymerization process whereby at least the α-olefin copolymer is produced using a single site or metallocene catalyst.

In any embodiment the α-olefin copolymer is made in commonly known “solution” processes. For example, copolymerizations are desirably carried out in a single-phase, liquid-filled, stirred tank reactor with continuous flow of feeds to the system and continuous withdrawal of products under steady state conditions. All polymerizations can be performed in a system with a solvent comprising predominantly C6 alkanes, referred to generally as “hexane” solvent, using soluble metallocene catalysts or other single-site catalysts and discrete, non-coordinating borate anion as co-catalysts. A homogeneous dilute solution of tri-n-octyl aluminum in hexane may be used as a scavenger in concentrations appropriate to maintain reaction. Chain transfer agents, such as hydrogen, can be added to control molecular weight. Polymerizations can be run at high temperatures, such as greater than 100 or 120 or 130 or 140° C. (or within a range from 120 or 130° C. to 150 or 160 or 170° C.) and high conversions to maximize macromer re-insertions that create long chain branching, if so desired. This combination of a homogeneous, continuous, solution process helped to ensure that the products had narrow composition and sequence distributions.

The reactor(s) can be maintained at a pressure in excess of the vapor pressure of the reactant mixture to keep the reactants in the liquid phase. In this manner the reactors can be operated liquid-full in a homogeneous single phase. Ethylene and propylene feeds can be combined into one stream and then mixed with a pre-chilled hexane stream. A hexane solution of a tri-n-octyl aluminum scavenger may be added to the combined solvent and monomer stream just before it entered the reactor to further reduce the concentration of any catalyst poisons. A mixture of the catalyst components in solvent may be pumped separately to the reactor and entered through a separate port.

The reaction mixture may be stirred aggressively such as by using a magna-drive system with three directionally opposed tilt paddle stirrers set to, for example, some value between 600 to 900 rpm, to provide thorough mixing over a broad range of solution viscosities. Flow rates can be set to maintain an average residence time in the reactor of 5 to 10 or 20 mins. On exiting the reactor the copolymer mixture may be subjected to quenching, a series of concentration steps, heat and vacuum stripping and pelletization, or alternatively, may be fed to a subsequent reactor where propylene will be polymerized, or fed to a line containing solution or slurry (or a combination of both) polypropylene where intimate mixing may occur. Water or water/alcohol mixture is then supplied to quench the polymerization reaction, which might otherwise continue in the presence of surviving catalyst, unreacted monomer, and elevated temperature. Antioxidant can be also used to quench the polymerization reaction.

When long chain branched copolymers are desired, the polymerization process condition can be tuned and catalyst can be chosen to enhance the formation LCB molecules. LCB structures can be obtained when a polymer chain (also referred as macromonomer) with reactive polymerizable groups is reinserted into another polymer chain during the polymerization of the latter. The resulting product comprises a backbone of the second polymer chain with branches of the first polymer chains (i.e., macromonomer) extending from the backbone. The macromonomer can be generated in situ during the termination step of the polymerization and has a vinyl group at the end of the polymer chain. LCB is formed through re-insertion of in situ generated vinyl-terminated macromonomers during the formation of a polymer chain. The re-insertion is controlled through reaction kinetics of macromonomer insertion and diffusion. Level of branching depends on the concentration of the reactive group and reinsertion rate of reactive macromonomers. The macromonomer incorporation also competes with monomer insertion during chain growth. Monomer insertion, however, is much easier/faster than macromonomer incorporation due to its smaller size. A process with low monomer concentration and high vinyl chain end macromonomers favors the macromonomer reinsertion. To obtain a highly branched copolymer, the temperature is raised to an extra-elevated level by the use of a selected catalyst system. The catalyst system is selected to provide high temperature stability and to incorporate comonomer and macromonomer readily. In addition, monomer and comonomer conversion can be increased to increase the relative concentration of the macromonomers and decrease the relative concentration of monomers and again favoring macromer incorporation and LCB formation.

Alternatively, a diene with at least two polymerizable double bonds can used to make branched copolymers. The diene can be incorporated into a polymer chain through one polymerizable bond in a similar manner as the incorporation of commonly used comonomers such as 1-hexene and 1-octene. Each insertion of a diene into a growing polymer chain produces a dangling vinyl group. These reactive polymer chains can be then incorporated into another growing polymer chain during polymerization through the second dangling double bond of a diene. This doubly inserted diene creates a linkage between two polymer chains and leads to branched structures.

In an adiabatic polymerization process, high reaction temperature can be achieved through heat of polymerization reaction. Increased temperatures can be reached by increasing the polymerization rate through increasing the amount of monomer and comonomer converted to polymer per unit time using increased levels of catalyst and increased monomer concentrations. Increased polymerization temperatures may themselves be associated with increased activity so that the catalyst addition rate may need to be changed to reach stable operating conditions. Increased monomer conversions may be reached by increasing catalyst levels or increasing the reactor residence times without increasing the monomer concentration so that monomer is consumed to a greater extent.

The polymerization may be performed adiabatically using a catalyst system including a hafnocene having two cyclopentadienyl groups connected by a bridging structure, preferably a single atom bridge. The ionic activator preferably has at least two polycyclic ligands, especially at least partly fluorinated. The use of a highly active metallocene catalyst and substantially equimolar ionic activator may permit reduced catalyst residue. Thus produced is the α-olefin copolymer component of the inventive TPOs.

A polymer can be recovered from the effluent of either the first polymerization step or the second polymerization step by separating the polymer from other constituents of the effluent using conventional separation means. For example, polymer can be recovered from either effluent by coagulation with a non-solvent, such as methanol, isopropyl alcohol, acetone, or n-butyl alcohol, or the polymer can be recovered by stripping the solvent or other media with heat or steam. One or more conventional additives such as antioxidants can be incorporated in the polymer during the recovery procedure. Possible antioxidants include phenyl-beta-naphthylamine, di-tert-butylhydroquinone, triphenyl phosphate, heptylated diphenylamine, 2,2′-methylene-bis(4-methyl-6-tert-butyl)phenol, and 2,2,4-trimethyl-6-phenyl-1,2-dihydroquinoline. Other methods of recovery such as by the use of lower critical solution temperature (LCST) followed by devolatilization are also envisioned. For LCST separation, the effluent of polymerization reactor may be passed to heat exchangers to raise the temperature to 200 or 210 or 220 or 230° C. or more. Liquid phase separation is then effected by a rapid pressure drop as the polymerization mixture passes through a let-down valve in a liquid phase separation vessel, in which the pressure drops quickly from 200 to 100 Bar down to a value between 20 to 60 bar. Inside the vessel an upper lean phase is formed with less than 0.1 wt % of polymer and a lower polymer rich phase with 30 to 40 wt % of polymer. The concentration in the polymer rich phase is approximately double to triple that in the polymerization effluent. After further removal of solvent and monomer in a low-pressure separator and devolatilizer, pelletized polymer can be removed from the plant for physical blending with polypropylene. If in situ blends are preferred, the removal of solvent takes place after intimate mixing with the solution or slurry phase polypropylene.

The lean phase and volatiles removed downstream of the liquid phase separation are recycled to be part of the polymerization feed. In the process, a degree of separation and purification takes place to remove polar impurities that might undermine the activity of the catalyst. Any internally unsaturated olefins, which are difficult to polymerize would gradually build up in the lean phase and recycle streams. Any adverse effects on the polymerization activity, may be mitigated by removing these olefins from the recycle stream and/or encouraging their incorporation in the polymer, favored by high polymerization temperatures.

When combining the polypropylene and copolymer components, the complex viscosity (CV) of each component can be tailored to a desirable level by adjusting the MFR, Mw, and other features of the components such as their comonomer content, etc. Desirably, the relative amounts of ethylene derived units in the α-olefin copolymer, the amount of the α-olefin copolymer in the composition, the molecular weight of the α-olefin copolymer, or any combination of these are adjusted to bring satisfy the formula 0.2≦CV_{α-olefin}/CV_{PP}≦5 when the CVs are measured at the same frequency and temperature. Also, the relative amounts of ethylene derived units in the polypropylene, the amount of the polypropylene in the composition, the molecular weight of the polypropylene, or any combination of these are adjusted to bring satisfy the formula 0.2≦CV_{α-olefin}/as CV_{PP}≦5 when the CVs are measured at the same frequency and temperature. Finally, any combination of features for the polypropylene and copolymer components can be adjusted, for example, the MFR or molecular weight of the polypropylene and the ethylene content of the copolymer can be simultaneously adjusted to satisfy the formula 0.2≦CV_{α-olefin}CV_{PP}≦5 when the CVs are CVᵢₙ/measured at the same frequency and temperature.

### The Thermoplastic Polyolefin Composition

Whether through in situ reactor blending or physical blending, resulting from the process is a thermoplastic polyolefin composition comprising discrete domains comprising (or consisting essentially of, or consist of) within the range from 8, or 10, or 12 wt % to 45, or 50 wt %, by weight of the TPO, α-olefin copolymer and a continuous phase of polypropylene, wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature.

Desirably, the inventive thermoplastic polyolefin compositions may include two or more polypropylenes as described herein, and/or may include two or more α-olefin copolymers as described herein. But in a preferred embodiment, no other types of polyolefins are present in the inventive thermoplastic polyolefin composition, such as, for example, a plastomers (C2/C3 or C2/C6 or C2/C8 copolymer, wherein the ethylene-derived content is from 50 to 90 wt %) or polyethylenes (wherein the ethylene-derived content is from 70 to 100 wt %), or propylene-based elastomers (C3/C2, wherein the ethylene-derived content is from 5 to 30 wt %).

In any embodiment the invention particularly includes a thermoplastic polyolefin composition comprising discrete α-olefin copolymer domains comprising (or consisting essentially of, or consist of) within the range from 8, or 10, or 12 wt % to 45, or 50 wt %, by weight of the TPO, α-olefin copolymer having a MWD within the range from 2.0, or 2.5 to 3.0, or 3.5, or 4.0, or 4.5, and an MFR (230° C./2.16 kg) within the range from 4, or 6, or 8 g/10 min to 12, or 14, or 16 g/10 min, wherein the α-olefin copolymer comprises within the range from 20, or 30 wt % to 50, or 55 wt % ethylene derived units, and the remainder of propylene-derived units; and within the range from 92, or 90, or 88 wt % to 55, or 50 wt %, by weight of the TPO, of a continuous phase of polypropylene having a MFR (230° C./2.16 kg) within the range from 5 g/10 min to 40 g/10 min, and a unimodal or bimodal MWD within the range from 2.0, to 20.0; wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature. In any embodiment, the complex viscosity of the copolymer and polypropylene components is measured at a frequency within a range from 0.01, or 1, or 10, or 50 rad/sec to 80, or 100, or 150, or 200 rad/sec (at a temperature in between 190 and 230° C.). Further, in any embodiment the inventive TPOs have domains that are less than 10 μm in average diameter, or within a range of from 0.10, or 0.20 μm to 0.80, or 1.0, or 2.0, or 5.0, or 10 μm in average diameter.

Not readily knowing the molecular weight characteristics of the components of a blend, especially the molecular weights, the deconvolution of the GPC data from bimodal and/or bi-component ICP or TPO compositions and subsequent mathematical fitting can allow for calculation of individual molecular weights of the components. The molecular weight properties as characterized by GPC can be described by a log Normal function in which the probability density function (PDF) is shown in Equation 1:

$$f ( M ) = \frac{dWt}{d log M} = \frac{1}{\sqrt{2 π} σ} {e}^{- \frac{1}{2} {( \frac{lo g ( M / {M}_{p} )}{σ} )}^{2}} , \qquad ( 1 )$$

where the peak width σ and the peak molecular weight (Mₚ) are the parameters necessary for specific calculations. The weight averaged and number averaged molecular weights (Mw and Mn) can be derived from equation (1). The area under each peak corresponds to the mass fraction of each component. The Mw, and if desired, the Mn and Polydispersity Index (PDI) for each component is then calculated from the fitted Mp and σ parameters in the corresponding peak with equations (2), (3) and (4). The curve fitting can be performed with software Igor Pro V6:

$$\begin{matrix} {M}_{w} = \frac{\int MdWt}{\int dWt} = \frac{\int Mfd ( log M )}{\int fd ( log M )} = {M}_{p} {e}^{\frac{l {n}^{2} 10}{2} {σ}^{2}} = {M}_{p} {e}^{2.651 {σ}^{2}} , & ( 2 ) \\ {M}_{n} = \frac{\int dWt}{\int \frac{dWt}{M}} = \frac{\int fd ( log M )}{\int \frac{f}{M} d ( log M )} = {M}_{p} {e}^{- \frac{l {n}^{2} 10}{2} {σ}^{2}} = {M}_{p} {e}^{- 2.651 {σ}^{2}} , & ( 3 ) \\ PDI = \frac{{M}_{W}}{{M}_{n}} = {e}^{l {n}^{2} 10 {σ}^{2}} = {e}^{5.302 {σ}^{2}} . & ( 4 )\end{matrix}$$

As mentioned above, various additives may be present in one or both phases of the inventive compositions to enhance a specific property or improve processing. Additives which may be incorporated include, but are not limited to, processing oils, fire retardants, antioxidants, plasticizers, pigments, vulcanizing or curative agents, vulcanizing or curative accelerators, cure retarders, processing aids, flame retardants, tackifying resins, flow improvers, antiblocking agents, coloring agents, lubricants, mold release agents, nucleating agents, reinforcements, and fillers (including granular, fibrous, or powder-like) may also be employed. As mentioned, certain “additives” such as elastomeric propylene-based polymers (copolymers of propylene and no more than 50 wt % of ethylene or a C4 to C10 comonomer), elastomeric ethylene-based polymers (copolymers of ethylene and no more than 50 wt % of C3 to C10 comonomers), and/or styrenic copolymers are absent from the inventive compositions in any embodiment.

Desirably, the inventive thermoplastic polyolefin compositions have an Izod Impact Strength (23° C.) greater than 2, or 4 or 6 ft-lb/in; or within a range of from 2, or 4 ft-lb/in to 10, or 12, or 16 ft-lb/in, measured as described below. Also desirably, the inventive TPO compositions have a Flexural Modulus of greater than 800 or 900 or 1100 or 1200 MPa, or within a range of from 800, or 850, or 900 MPa to 1000, or 1100, or 1200, or 1400 MPa, measured as described below.

The TPO composition may be further blended with other major (5 to 30, or 40 wt % by weight of the total composition) and are useful for many applications, including fibers and/or fabrics that can then be formed into diapers, hygiene products, medical gowns and masks, filters, insulation, sheets, films, and layered as sheets or films in such articles as pallets. The TPO compositions may also be made into articles via injection molding, thermoforming, compression molding, and/or foam extrusion. Suitable articles would include automotive components, appliance components, drinking cups, food containers, food plates, and any number of other items.

The various descriptive elements and numerical ranges disclosed herein for the inventive methods and compositions can be combined with other descriptive elements and numerical ranges to describe the invention(s); further, for a given element, any upper numerical limit can be combined with any lower numerical limit described herein, including the examples. The features of the inventions are demonstrated in the following non-limiting examples.

### Examples

To document practical feasibility of the invention, we present two sets of examples of model blends composed of ZN produced isotactic polypropylene matrix (MFR=70 and 35 dg/min) and ethylene-propylene random copolymers as the rubber component. The α-olefin copolymer component has a C₂ content of about 50 wt % to ensure low compatibility with PP, but display distinct viscosities at high and low shear rates. Test methods are described herein along with explanations of the inventive examples.

Melt Flow Rate (MFR).

MFR is measured in grams of polymer per 10 min (g/10 min or its equivalent unit dg/min and was measured according to ASTM D1238 (2.16 kg, 230° C.). For reactor granule and/or powder PP samples that are not stabilized, the following sample preparation procedure is followed before measuring the MFR. A solution of Butylated Hydroxy Toluene (BHT) in hexane is prepared by dissolving 40±1 grams of BHT into 4000±10 ml of hexane. Weigh 10±1 grams of the granule/powder PP sample into an aluminum weighing pan. Add 10±1 ml of the BHT/hexane solution into the aluminum pan under a Hood. Stir the sample, if necessary, to thoroughly wet all the granules. Place the sample slurry in a vacuum oven at 105°±5° C. for a minimum of 20 min. Remove the sample from the oven and place in a nitrogen purged desiccator a minimum of 15 mins allowing the sample to cool. Measure the MFR following ASTM D1238 procedure.

Flexural Modulus:

The flexural modulus is measured according to ASTM D790A, using a crosshead speed of 1.27 mm/min (0.05 in/min), and a support span of 50.8 mm (2.0 in) using an Instron machine.

Notched Izod Impact Strength:

The Notched Izod impact strength is measured as per ASTM D256 at room temperature (21° C.), using equipment made by Empire Technologies Inc.

Dynamic Viscosity (Also Referred to as Complex Viscosity or Dynamic Shear Viscosity):

Dynamic shear melt rheological data was measured with an Advanced Rheometrics Expansion System (ARES) using parallel plates (diameter=25 mm) in a dynamic mode under nitrogen atmosphere. For all experiments, the rheometer was thermally stable at 190° C. for at least 30 mins before inserting compression-molded sample of resin onto the parallel plates. To determine the samples' viscoelastic behavior, frequency sweeps in the range from 0.01 to 385 rad/s were carried out at a temperature of 200° C. under constant strain. Depending on the molecular weight and temperature, strains of 10% and 15% were used and linearity of the response was verified. A nitrogen stream was circulated through the sample oven to minimize chain extension or cross-linking during the experiments. All the samples were compression molded at 190° C. and no stabilizers were added. A sinusoidal shear strain is applied to the material. If the strain amplitude is sufficiently small the material behaves linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90.

Differential Scanning Calorimetry (DSC) for Determination of Crystallization and Melting Temperatures.

Peak crystallization temperature (T_{c}), peak melting temperature (Tₘ), and heat of fusion (ΔH_{f}) were measured via Differential Scanning calorimetry (DSC) using a DSCQ200 (TA Instruments) unit. The DSC was calibrated for temperature using indium as a standard. The heat flow of indium (28.46 J/g) was used to calibrate the heat flow signal. A sample of 3 to 5 mg of polymer, typically in pellet or granule form, was sealed in a standard aluminum pan with flat lids and loaded into the instrument at room temperature. In the case of determination of T_{c} and Tₘ, corresponding to 10° C./min cooling and heating rates, respectively, the following procedure was used. The sample was first equilibrated at 25° C. and subsequently heated to 200° C. using a heating rate of 10° C./min (first heat). The sample was held at 200° C. for 5 min to erase any prior thermal and crystallization history. The sample was subsequently cooled down to 25° C. with a constant cooling rate of 10° C./min (first cool). The sample was held isothermal at 25° C. for 5 min before being heated to 200° C. at a constant heating rate of 10° C./min (second heat). The exothermic peak of crystallization (first cool) was analyzed using the TA Universal Analysis software and the peak crystallization temperature (T_{c}) corresponding to 10° C./min cooling rate was determined. The endothermic peak of melting (second heat) was also analyzed using the TA Universal Analysis software and the peak melting temperature (Tₘ) corresponding to 10° C./min heating rate was determined. Unless otherwise indicated, reported values of T_{c} Tₘ in this invention refer to a cooling and heating rate of 10° C./min, respectively.

The ZN produced polypropylenes (where “higher MW PP” corresponds to PP-1, and “lower MW PP” corresponds to PP-2):
PP-1: MFR (230° C., 2.16 kg)=70 dg/min, stabilizer: 1000 ppm Irganox™ 1010, 1000 ppm Irgafos™ 168, nucleating agent: 3000 ppm sodium benzoate;
PP-2: MFR (230° C., 2.16 kg)=35 dg/min, stabilizer: 1000 ppm Irganox™ 1010, 1000 ppm Irgafos™ 168, nucleating agent: 3000 ppm sodium benzoate.

The PP components have melt flow rates measured at 230° C./2.16 kg according to ASTM D1238 (MFR) in the range 10-100 dg/min displays shear thinning (non-Newtonian) behavior at angular frequency lower than 10 rad/s. Rheological behavior of PP component can be identified by broadening distribution of molecular weights by blending two or more PPs with different mean molecular weights in solution and/or by blending linear and branched PPs in solution.

The Molecular Weight Characteristics of the Polymers.

Polymer molecular weight (weight-average molecular weight, M_{w}, number-average molecular weight, Mₙ, and z-averaged molecular weight, M_{z}), and molecular weight distribution (M_{w}/Mₙ) are determined using Size-Exclusion Chromatography (“GPC”). Equipment consists of a High Temperature Size Exclusion Chromatograph (either from Waters Corporation or Polymer Laboratories), with a differential refractive index detector (DRI), an online light scattering detector, and a viscometer (SEC-DRI-LS-VIS). For purposes of the claims, SEC-DRI-LS-VIS shall be used. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC.

Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/ml at room temperature and 1.324 g/ml at 135° C. The injection concentration can range from 1.0 to 2.0 mg/ml, with lower concentrations being used for higher molecular weight samples.

Prior to running each sample the DRI detector and the injector are purged. Flow rate in the apparatus is then increased to 0.5 ml/min, and the DRI allowed to stabilize for 8 to 9 hours before injecting the first sample. The LS laser is turned on 1 to 1.5 hours before running samples.

The concentration, c, at each point in the chromatogram is calculated from the DRI signal after subtracting the prevailing baseline, I_{DRI}, using the following equation:

c=K_{DRI}I_{DRI}/(dn/dc)

where K_{DRI} is a constant determined by calibrating the DRI, and (dn/dc) is the same as described below for the LS analysis. The processes of subtracting the prevailing baseline (i.e., background signal) and setting integration limits that define the starting and ending points of the chromatogram are well known to those familiar with SEC analysis. Units on parameters throughout this description of the SEC method are such that concentration is expressed in g/cm³, molecular weight is expressed in g/mole, and intrinsic viscosity is expressed in dL/g.

The light scattering detector is a Wyatt Technology High Temperature mini-DAWN. The polymer molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and K_{O} is the optical constant for the system:

$${K}_{o} = \frac{4 {π}^{2} {{n}^{2} ( dn / d c )}^{2}}{{λ}^{4} {N}_{A}}$$

in which N_{A} is Avogadro's number, and (dn/dc) is the refractive index increment for the system. The refractive index, n=1.500 for TCB at 135° C. and λ=690 nm. In addition, A₂=0.0015 and (dn/dc)=0.104 for polyethylene in TCB at 135° C.; both parameters may vary with average composition of an ethylene copolymer. Thus, the molecular weight determined by LS analysis is calculated by solving the above equations for each point in the chromatogram; together these allow for calculation of the average molecular weight and molecular weight distribution by LS analysis.

A high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity for the solution flowing through the viscometer at each point in the chromatogram, (ηₛ)ᵢ, is calculated from the ratio of their outputs. The intrinsic viscosity at each point in the chromatogram, [η]ᵢ, is calculated by solving the following equation (for the positive root) at each point i:

(ηₛ)ᵢ=cᵢ[η]ᵢ+0.3(cᵢ[η]ᵢ)²

where cᵢ is the concentration at point i as determined from the DRI analysis.

The branching index (g′ᵥᵢₛ) is calculated using the output of the SEC-DRI-LS-VIS method (described above) as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ is defined as:

$${g}_{vis}^{′} = \frac{{[ η ]}_{avg}}{k {M}_{v}^{α}}$$

where the Mark-Houwink parameters k and α are given by k=0.000579 for polyethylene homopolymer and α=0.695 for all polyethylene polymers. For ethylene copolymers, k decreases with increasing comonomer content. M_{V} is the viscosity-average molecular weight based on molecular weights determined by LS analysis.

Experimental and analysis details not described above, including how the detectors are calibrated and how to calculate the composition dependence of Mark-Houwink parameters and the second-virial coefficient, are described by T. Sun, P. Brant, R. R. Chance, and W. W. Graessley, in 34(19) MACROMOLECULES, 6812-6820 (2001).

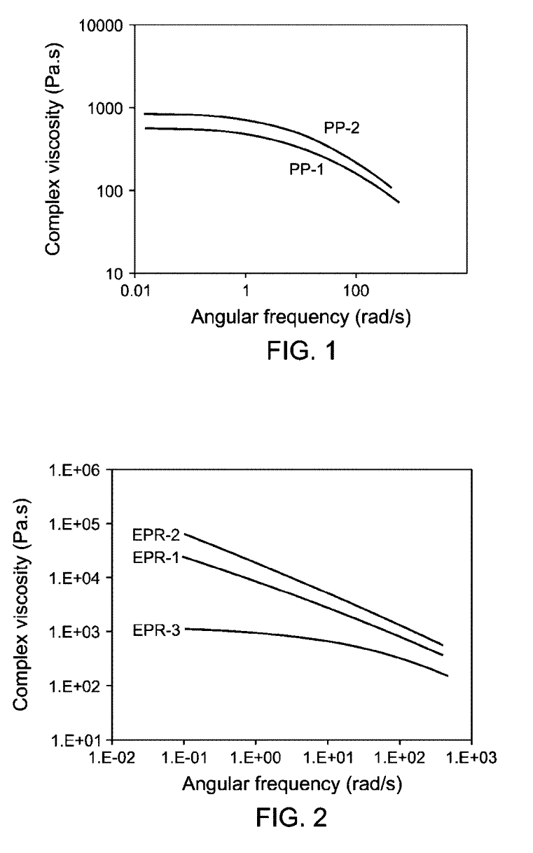

Results from GPC and MFR measurements are in Table 1. Results from rheological measurements at 200° C. (ARES, Rheometrics, plate-plate geometry) are in FIG. 1.

TABLE 1
Properties of the iPP used in the examples

| Parameter | PP-1 | PP-2 |
|---|---|---|
| Mw (kg/mole) | 157 | 185.4 |
| Mn | 33 | 33.6 |
| Mz | 416 | 366 |
| Mw/Mn | 4.8 | 5.52 |
| Mz/Mw | 2.7 | 2.75 |
| MFR (g/10 min) | 70 | 35 |

Three ethylene-propylene random copolymers with varying degree of branching were produced for the inventive TPO blends.

The three EPRs were made in a continuous stirred-tank reactor operated in a solution process. The reactor was a 1.0-liter stainless steel autoclave reactor and was equipped with a stirrer, a water cooling/steam heating element with a temperature controller and a pressure controller. Solvents and monomers (e.g., ethylene and propylene) were first purified by passing through columns of alumina and molecular sieves. The purified solvents and monomers were then chilled to below 4° C. by passing through a chiller before being fed into the reactor through a manifold. Ethylene was delivered as a gas solubilized in the chilled solvent/monomer mixture. Solvent and monomers were mixed in the manifold and fed into the reactor through a single port. All liquid flow rates were controlled and measured using Brooksfield mass flow controllers. The 1,9-decediene was purified and then diluted with isohexane and fed into the reactor using a metering pump.

The catalyst used was [di(p-triethylsilylphenyl)methylene] (cyclopentadienyl) (3,8-di-t-butylfluorenyl)hafnium dimethyl. The metallocene was preactivated with N,N-dimethyl anilinium tetrakis (pentafluorophenyl) borate at a molar ratio of about 1:1 in toluene. The preactivated catalyst solution was kept in an inert atmosphere and was fed into the reactor using ISCO syringe pump through a separated line. Catalyst and monomer contacts took place in the reactor.

As an impurity scavenger, 200 ml of tri-n-octyl aluminum (TNOA) (25 wt % in hexane, Sigma Aldrich) was diluted in 22.83 kilogram of isohexane. The TNOA solution was stored in a 37.9-liter cylinder under nitrogen blanket. The solution was used for all polymerization runs until about 90% of consumption, and then a new batch was prepared. The feed rates of the TNOA solution were adjusted in a range from 0 (no scavenger) to 4 ml per min to optimize catalyst activity.

The reactor was first prepared by continuously N₂ purging at a maximum allowed temperature, then pumping isohexane and scavenger solution through the reactor system for at least one hour. Monomers and catalyst solutions were then fed into the reactor for polymerization. Once the activity was established and the system reached a steady state, the reactor was lined out by continuing operation of the system under the established condition for a time period of at least four times of mean residence time prior to sample collection. The reactor effluent, containing mostly solvent, polymer and unreacted monomers, exited the reactor through a pressure control valve that reduced the pressure to atmospheric. This caused most of the unconverted monomers in the solution to flash into a vapor phase which was vented from the top of a sample collecting box. The liquid phase, comprising mainly polymer and solvent, was collected for polymer recovery. The collected samples were first air-dried in a hood to evaporate most of the solvent, and then dried in a vacuum oven at a temperature of about 90° C. for about 12 hours. The vacuum oven dried samples were weighed to obtain yields. All the reactions were carried out at a pressure of about 350 psig. The polymerization process condition and some characterization data are listed in Table 2. For each polymerization run, the catalyst feed rate and scavenger feed rate were adjusted to achieve a desired conversion listed in Table 2.

TABLE 2
Process condition and some characterization data for the EPR

| Example # | EPR-1 | EPR-2 | EPR-3 |
|---|---|---|---|
| Catalyst feed rate (mol/min) | 8.83 × 10⁻⁰⁸ | 8.83 × 10⁻⁰⁸ | 8.83 × 10⁻⁰⁸ |
| Polymerization temperature (° C.) | 120 | 120 | 120 |
| Ethylene feed rate (SLPM) | 5 | 5 | 5 |
| Propylene feed rate (g/min) | 14 | 14 | 10 |
| 1,9-decadiene feed rate (ml/min) | 0.024 | 0.037 | — |
| H₂ feed rate (slpm) | 12 | 12 | 15 |
| Isohexane feed rate (g/min) | 82.7 | 82.7 | 82.7 |
| Yield (g/min) | 11.4 | 10.7 | 10.1 |
| Conversion (%) | 57.9% | 54.4% | 64.8% |
| Complex shear viscosity at 0.1 rad/ | 23,556 | 63,800 | 1,432 |
| sec (Pa · s) | | | |
| Complex shear viscosity at 100 rad/ | 822 | 1,279 | 330 |
| sec (Pa · s) | | | |
| MFR (gram/10 min) | 1.0 | 0.4 | 10.9 |
| Mn DRI (g/mol) | 58,002 | 59,391 | 45,920 |
| Mw DRI (g/mol) | 157,140 | 184,826 | 94,767 |
| Mz DRI (g/mol) | 364,985 | 489,372 | 163,178 |
| Mn LS (g/mol) | 70,734 | 71,682 | 53,284 |
| Mw LS (g/mol) | 171,978 | 212,517 | 96,598 |
| Mz LS (g/mol) | 402,386 | 598,694 | 153,789 |
| Branching Index, g′ᵥᵢₛ | 0.868 | 0.817 | 0.958 |
| Glass transition temperature (° C.) | −53.8 | −51.2 | −56.8 |
| Ethylene content (wt %) | 41.33 | 40.83 | 46.57 |

Results from rheological measurements at 200° C. (ARES, Rheometrics, plate-plate geometry) are in FIG. 2, where the curves correspond to EPR-1, EPR 2, and EPR-3, each shorthand for the example α-olefin copolymers. These are summarized in Table 3, where the Viscosity ratios, rubber complex viscosity/PP complex viscosity, at an angular frequency 100 rad/s.

TABLE 3
Viscosity Ratios, 100 rad/s

| | PP-1 | PP-2 |
|---|---|---|
| EPR-1 | 5.0 | 3.8 |
| EPR-2 | 7.8 | 5.9 |
| EPR-3 | 1.7 | 1.3 |

The polypropylenes in Table 1 were then used to form TPOs by blending with ethylene-propylene random copolymers. Blends were prepared by:
70 g of PP in a fine powder form (grinded under liquid nitrogen) was mixed with α-olefin copolymer solution in hexane at room temperature (30 g α-olefin copolymer+100 ml hexane) in ajar (total charge: 100 grams; 30 wt % of α-olefin copolymer in PP).
Blend was hand mixed with spatula and dried at 80° C. in a vacuum oven.
Prepared dry-blend was then extruded on ThermoPrism twin screw extruded (D=16 mm) at 200° C. and velocity 250 RPM.
Extruded blend was pelletized and used for injection molding on Boy injection Molding Machine under standard injection molding protocol at 190-200° C. to make specimens for Flexural Modulus and Izod Impact measurements.
Flexural modulus was measured according to ASTM D790 with an Instron Tensile Machine at 23° C. and a velocity 1 mm/min.
Izod impact toughness was measured according to ASTM D256 with a CEAST Impactor using a 15 J pendulum and a velocity 3.16 m/s at 23° C.
Rubber droplet morphology was assessed using a ZEISS EVO Scanning Electron Microscopy of chemically etched surfaces prepared by cryofacing injection molded Izod bars.
Rheology of prepared blend was measured using ARES Rheometrics rheometer at 200° C. with a plate-plate geometry.

Impact Toughness:

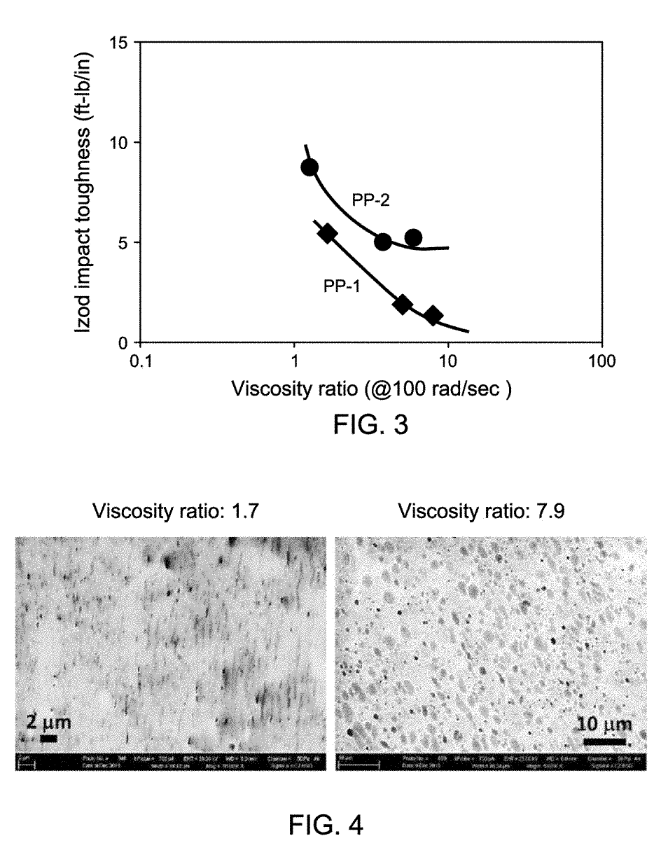

Attached plot represents a dependence of Izod impact toughness measured at room temperature on the melt viscosity ratio between rubber and PP during extrusion. Maximum in impact performance was observed as the melt viscosity of rubber approached viscosity of PP. As will be shown below, this was caused by better momentum transfer between molten component in the extruder and finer rubber droplet morphologies produced. These results are shown graphically in FIG. 3.

Morphology:

SEM images document that decreasing viscosity mismatch between PP and rubber during extrusion leads to considerably finer droplet morphology and, hence, improved impact performance. These results are shown in FIG. 4.

Rheology:

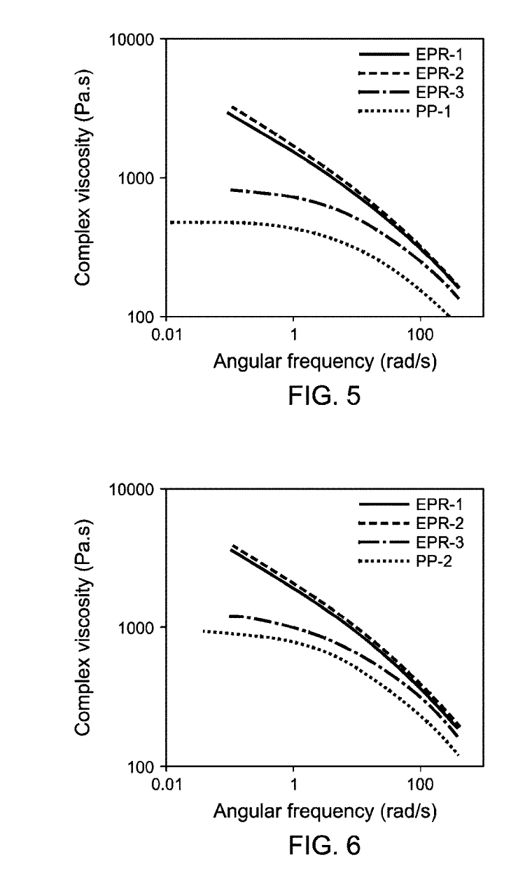

Complex viscosity vs. Angular Frequency data shown below demonstrate that all blends exhibit similar viscosities at velocities 100 rad/s and higher. This is a very important rheological property of PP/Rubber systems and it documents that matching viscosity of α-olefin copolymer with that of PP allows for using lower-MFR PP without significant effect on processing viscosity of a blend. Obviously, lower-MFR PP provides boost in strength as shown above. These results are shown graphically in FIGS. 5 and 6.

Stiffness/Toughness Balance:

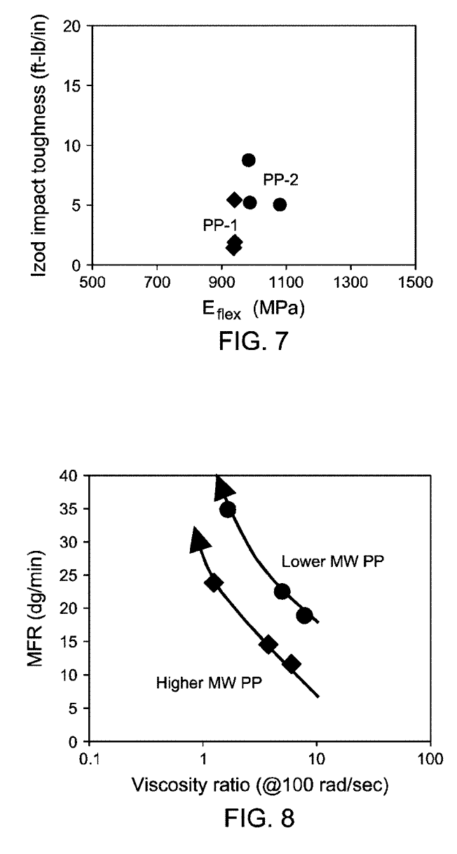

All blend compositions presented to document the invention show good balance between toughness and stiffness. Theoretical value of flexural modulus of an incompatible blend with 30 wt % of amorphous rubber is about 1000 MPa, depending on micromechanics model used for the calculation. All of the blends are close to this value. These results are shown graphically in FIG. 7.

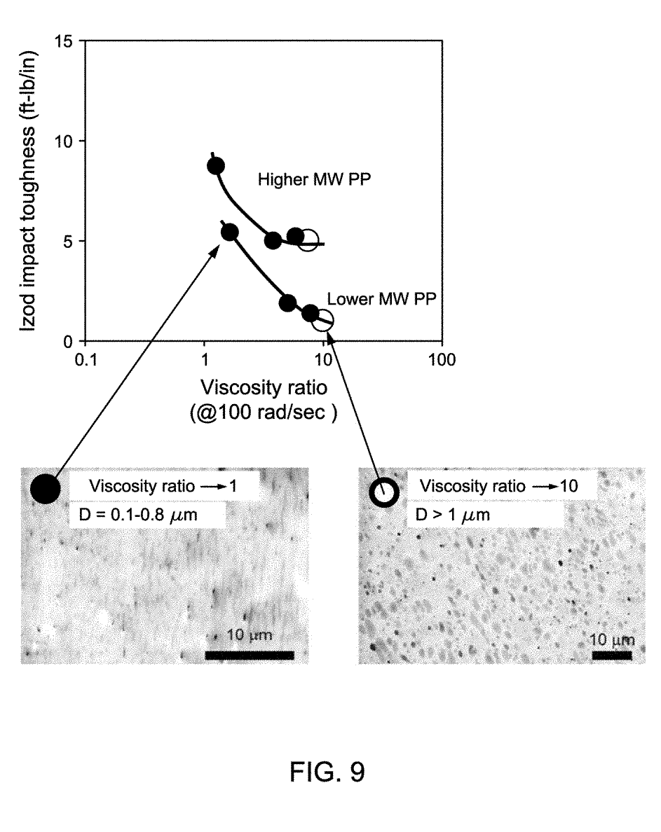

To summarize, the experimental examples demonstrate that decreasing viscosity mismatch between PP matrix and the rubber component in TPO blends is a feasible strategy that may provide boost in toughness while not hurting stiffness and rheological behavior. Matching viscosities of the copolymer or rubber and propylene homopolymer in TPO blends allows for higher molecular weight (lower MFR) polypropylenes to be used as reflected in FIG. 8 and FIG. 9. Toughness, stiffness, and melt viscosity all improved with the inventive TPOs compared to traditional ZN ICPs.

Now, having described the various aspects of the inventive methods of forming the thermoplastic compositions, and the compositions themselves, described here in numbered paragraphs is:

P1. A thermoplastic polyolefin composition comprising discrete domains of α-olefin copolymer and a continuous phase of polypropylene, the TPO comprising (or consisting essentially of, or consisting of) within the range from 8 wt % to 60 wt % of the α-olefin copolymer, by weight of the thermoplastic polyolefin, and within the range from 92 wt % to 40 wt % of the polypropylene by weight of the thermoplastic polyolefin, wherein the complex viscosity of the α-olefin copolymer (CV_{α-olefin}) and polypropylene (CV_{PP}) satisfy the formula 0.2, or 0.4≦CV_{α-olefin}/CV_{PP}≦2, or 3, or 4, or 5 when the CVs are measured at the same frequency and temperature.
P2. The thermoplastic polyolefin composition of paragraph 1, wherein the domains are less than 10 μm in average diameter, or within a range of from 0.10, or 0.20 μm to 0.80, or 1.0, or 2.0, or 5.0, or 10 μm in average diameter.
P3. The thermoplastic polyolefin composition of paragraphs 1 or 2, wherein the α-olefin copolymer comprises within the range from 20, or 30, or 40 wt % to 60, or 70, or 80 wt %, by weight of the copolymer, of ethylene derived units, and within the range from 20, or 30, or 40 wt % to 50, or 60, or 80 wt %, by weight of the copolymer, higher α-olefin derived units selected from one or more of propylene, 1-butene, 1-hexene, 1-octene, and, linear dienes.
P4. The thermoplastic polyolefin composition of any one of the preceding numbered paragraphs, wherein the α-olefin copolymer comprises within the range from 20, or 30 wt % to 50, or 55 wt % ethylene derived units, and the remainder of propylene-derived units and linear diene derived units.
P5. The thermoplastic polyolefin composition of any one of the preceding numbered paragraphs, wherein the relative amounts of ethylene derived units in the α-olefin copolymer and/or polypropylene, the amount of the α-olefin copolymer and/or polypropylene in the composition, the molecular weight of the α-olefin copolymer and/or polypropylene, or any combination of these are adjusted to bring satisfy the formula 0.2≦CV_{α-olefin}/CV_{PP}≦5 when the CVs are measured at the same frequency and temperature.
P6. The thermoplastic polyolefin composition of any one of the preceding numbered paragraphs, wherein the α-olefin copolymer has a molecular weight distribution (M_{w}/Mₙ) of less than 6.0, or 5.0, or 4.0, or within a range of from 1.8, or 2.0, or 2.5 to 4.0, or 6.0.
P7. The thermoplastic polyolefin composition of any one of the preceding numbered paragraphs, wherein the polypropylene has a MFR (230° C./2.16 kg) from less than 100 g/10 min; or within a range of from 2, or 5, or 10, or 20 g/10 min to 30, or 40, or 50, or 75, or 80 or 85, or 100 g/10 min.
P8. The thermoplastic polyolefin composition of any one of the preceding numbered paragraphs, wherein the polypropylene has a melting point (DSC) of greater than 140, or 150, or 155° C., or within a range of from 130, or 140, or 145° C. to 155, or 160 or 165° C.
P9. The thermoplastic polyolefin composition of any one of the preceding numbered paragraphs, wherein the polypropylene has a bimodal molecular weight distribution within the range of from 5.0, or 6.0, to 10.0, or 12.0, or 16.0, or 20.0.
P10. The thermoplastic polyolefin composition of any one of the preceding numbered paragraphs, wherein the polypropylene has a unimodal molecular weight distribution (M_{w}/Mₙ) of less than 6.0, or 5.0, or 4.0; or within a range of from 1.8, or 2.0, or 2.5 to 4.0, or 6.0.
P11. The thermoplastic polyolefin composition of any one of the preceding numbered paragraphs, having an Izod Impact Strength (23° C.) greater than 2, or 4 or 6 ft-lb/in; or within a range of from 2, or 4 ft-lb/in to 10, or 12, or 16 ft-lb/in.
P12. The thermoplastic polyolefin composition of any one of the preceding numbered paragraphs, having a Flexural Modulus within a range of from 800, or 850, or 900 MPa to 1,000, or 1,100, or 1,200, or 1,400 MPa.
P13. The thermoplastic polyolefin composition of any one of the preceding numbered paragraphs, wherein the α-olefin copolymer has an MFR (230° C./2.16 kg) within the range from 4, or 6, or 8 g/10 min to 12, or 14, or 16 g/10 min.
P14. A thermoplastic polyolefin composition comprising discrete α-olefin copolymer domains comprising (or consisting essentially of, or consisting of):
within the range from 8, or 10, or 12 wt % to 45, or 50, or 55, or 60 wt % α-olefin copolymer having a MWD within the range from 2.0 or 2.5 to 3.0 or 3.5 or 4.0, or 4.5, and an MFR (230° C./2.16 kg) less than 20 g/10 min, or within the range from 4, or 6, or 8 g/10 min to 12, or 14, or 16 g/10 min, wherein the α-olefin copolymer comprises within the range from 20, or 30 wt % to 50, or 55 wt % ethylene derived units, and the remainder of propylene-derived units; and
within the range from 92, or 90, or 88 wt % to 55, or 50 wt % of a continuous phase of polypropylene having a MFR (230° C./2.16 kg) of less than 100 g/10 min, or within the range from 2, or 5, or 10, or 20 g/10 min to 30, or 40, or 50, or 75, or 80 or 85, or 100 g/10 min, and a unimodal or bimodal MWD within the range from 2.0 or 2.5, or 3.0, or 3.5 to 4.5, or 5.5, or 6.5, or 7.0, or 8.0, or 10.0, or 12.0, or 16.0, or 20.0;
wherein the complex viscosity of the α-olefin copolymer (CV_{α-olefin}) and polypropylene (CV_{PP}) satisfy the formula 0.2, or 0.4≦CV_{α-olefin}/CV_{PP}≦2, or 3, or 4, or 5 when the CVs are measured at the same frequency and temperature; and
wherein the domains are less than 10 μm in average diameter, or within a range of from 0.10, or 0.20 μm to 0.80, or 1.0, or 2.0, or 5.0, or 10 μm in average diameter.
   P15. A thermoformed, injection molded, or blow molded, either foamed or not foamed, article comprising the thermoplastic polyolefin composition of any one of the previously numbered paragraphs.
   P16. A method of forming a thermoplastic polyolefin composition comprising discrete α-olefin copolymer domains within a continuous phase of polypropylene comprising combining within the range from 8 wt % to 60 wt % of the α-olefin copolymer, by weight of the thermoplastic polyolefin, and within the range from 92 wt % to 40 wt % of the polypropylene by weight of the thermoplastic polyolefin, wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature.
   P17. A method of forming the thermoplastic polyolefin composition comprising discrete α-olefin copolymer domains of any one of the preceding numbered paragraphs wherein the polypropylene and/or α-olefin copolymer are produced in separate solution processes with single-site or metallocene catalyst systems, either in parallel or sequentially, then blended while in a molten state.
   P18. A method of forming the thermoplastic polyolefin composition comprising discrete α-olefin copolymer domains of any one of the preceding numbered paragraphs, wherein the combining of the polypropylene and α-olefin copolymer takes place at the shear viscosity at which the complex viscosity of the α-olefin copolymer (CV_{α-olefin}) and polypropylene (CV_{PP}) satisfy the formula 0.2, or 0.4≦CV_{α-olefin/}CV_{PP}≦2, or 3, or 4, or 5; or at the shear viscosity at which the complex viscosity of the polypropylene and α-olefin copolymer is within 5 or 10 or 15% of one another.

Also disclosed is the use of the thermoplastic polyolefin composition of any one of the above paragraphs 1 to 14 in a thermoformed, injection molded, or blow molded (any of which may be either foamed or not foamed) article.

For all jurisdictions in which the doctrine of “incorporation by reference” applies, all of the test methods, patent publications, patents and reference articles are hereby incorporated by reference either in their entirety or for the relevant portion for which they are referenced.

1. A method of forming a thermoplastic polyolefin composition comprising discrete α-olefin copolymer domains within a continuous phase of polypropylene comprising combining within the range from 8 wt % to 60 wt %, by weight of the thermoplastic polyolefin composition, of the α-olefin copolymer, and within the range from 92 wt % to 40 wt %, by weight of the thermoplastic polyolefin, of the polypropylene, wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature.

2. The method of claim 1, wherein the domains are less than 10 μm in average diameter.

3. The method of claim 1, wherein the α-olefin copolymer comprises within the range from 20 wt % to 80 wt %, by weight of the copolymer, ethylene derived units, and within the range from 20 wt % to 80 wt %, by weight of the copolymer, higher α-olefin derived units selected from one or more of propylene, 1-butene, 1-hexene, 1-octene, and linear dienes.

4. The method of claim 1, wherein the α-olefin copolymer comprises within the range from 20 wt % to 60 wt %, by weight of the copolymer, ethylene derived units, and the remainder of propylene-derived units and, optionally, linear diene derived units.

5. The method of claim 1, wherein the relative amounts of ethylene derived units in the α-olefin copolymer, the amount of higher α-olefin copolymer in the composition, the molecular weight of the α-olefin copolymer, or any combination of these are adjusted to satisfy the formula 0.2≦CV_{α-olefin}/CV_{PP}≦5 when the CVs are measured at the same frequency and temperature.

6. The method of claim 1, wherein the α-olefin copolymer has a molecular weight distribution (M_{w}/Mₙ) of less than 6.0.

7. The method of claim 1, wherein the polypropylene has a MFR (230° C./2.16 kg) from less than 100 g/10 min.

8. The method of claim 1, wherein the α-olefin copolymer has an MFR (230° C./2.16 kg) from less than 20 g/10 min.

9. The method of claim 1, wherein the polypropylene has a melting point (DSC) of greater than 140° C.

10. The method of claim 1, wherein the polypropylene has a bimodal molecular weight distribution (M_{w}/Mₙ, MWD) within the range of from 5.0 to 20.

11. The method of claim 1, wherein the polypropylene has a unimodal molecular weight distribution (M_{w}/Mₙ, MWD) of less than 6.0.

12. The method of claim 1, wherein the α-olefin copolymer has a weight average molecular weight (Mw) within a range from 70,000 g/mol to 600,000 g/mol (GPC-DRI).

13. The method of claim 1, wherein the polypropylene and/or α-olefin copolymer are produced in separate solution or slurry processes with single-site or metallocene catalyst systems, either in parallel or sequentially, then blended, while in a slurry and/or solution state.

14. The method of claim 1, wherein the thermoplastic polyolefin composition is thermoformed, injection molded, or blow molded, either foamed or not foamed, into an article.

15. A thermoplastic polyolefin composition comprising discrete domains of α-olefin copolymer and a continuous phase of polypropylene comprising within the range from 8 wt % to 60 wt %, by weight of the thermoplastic polyolefin of the α-olefin copolymer, and within the range from 92 wt % to 40 wt %, by weight of the thermoplastic polyolefin, of the polypropylene, wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature.

16. The thermoplastic polyolefin composition of claim 15, wherein the domains are less than 10 μm in average diameter.

17. The thermoplastic polyolefin composition of claim 15, wherein the α-olefin copolymer comprises within the range from 20 wt % to 80 wt %, by weight of the copolymer, ethylene derived units, and within the range from 20 wt % to 80 wt %, by weight of the copolymer, higher α-olefin derived units selected from one or more of propylene, 1-butene, 1-hexene, 1-octene, and, linear dienes.

18. The thermoplastic polyolefin composition of claim 15, wherein the α-olefin copolymer comprises within the range from 20 wt % to 60 wt % ethylene derived units, and the remainder of propylene-derived units.

19. The thermoplastic polyolefin composition of claim 15, wherein the α-olefin copolymer has a molecular weight distribution (M_{w}/Mₙ) of less than 6.0.

20. The thermoplastic polyolefin composition of claim 15, wherein the polypropylene has a MFR (230° C./2.16 kg) from less than 100 g/10 min.

21. The thermoplastic polyolefin composition of claim 15, wherein the polypropylene has a bimodal molecular weight distribution within the range of from 5.0 to 20.0.

22. The thermoplastic polyolefin composition of claim 15, wherein the polypropylene has a melting point (DSC) of greater than 140° C.

23. The thermoplastic polyolefin composition of claim 15, wherein the polypropylene has a bimodal molecular weight distribution within the range of from 5.0 to 20.0.

24. The thermoplastic polyolefin composition of claim 15, wherein the polypropylene has a unimodal molecular weight distribution (M_{w}/Mₙ) of less than 6.0.

25. The thermoplastic polyolefin composition of claim 15, having an Izod Impact Strength (23° C.) is greater than 2 ft-lb/in.

26. The thermoplastic polyolefin composition of claim 15, having a Flexural Modulus within a range of from 800 MPa to 1400 MPa.

27. The thermoplastic polyolefin composition of claim 15, wherein the polypropylene and/or α-olefin copolymer are produced in separate solution processes with single-site or metallocene catalyst systems, either in parallel or sequentially, then blended while in slurry and/or solution.

28. A thermoformed, injection molded, or blow molded, either foamed or not foamed, article comprising the thermoplastic polyolefin composition of claim 15.

29. A thermoplastic polyolefin composition comprising discrete α-olefin copolymer domains comprising:
within the range from 8 wt % to 60 wt % α-olefin copolymer having a MWD within the range from 2.0 to 4.5, and an MFR (230° C./2.16 kg) of less than 20 g/10 min, wherein the α-olefin copolymer comprises within the range from 30 wt % to 55 wt % ethylene derived units, and the remainder of propylene-derived units; and
within the range from 92 wt % to 50 wt % of a continuous phase of polypropylene having a MFR (230° C./2.16 kg) of less than 100 g/10 min, and a unimodal or bimodal MWD within the range from 2.0 to 20.0;
wherein the complex viscosity of the α-olefin copolymer (CV_{α-olefin}) and polypropylene (CV_{PP}) satisfy the formula 0.2≦CV_{α-olefin}/CV_{PP}≦5 when the CVs are measured at the same frequency and temperature; and
wherein the domains are less than 10 μm in average diameter.
